(19) United States
(12) Patent Application Publication
(10) Pub. No.: US 2004/0258792 A1
(43) Pub. Date: Dec. 23, 2004

(54) Injection molding manifold having a heating system with two portions

(75) Inventors: George Olaru, Toronto (CA); Fabrice Fairy, Georgetown (CA)

Correspondence Address: STERNE, KESSLER, GOLDSTEIN & FOX PLLC, 1100 NEW YORK AVENUE, N.W., WASHINGTON, DC, 20005, US

(73) Assignee: Mold-Masters Limited

(21) Appl. No.: 10/873,459

(22) Filed: Jun. 23, 2004

Related U.S. Application Data
(60) Provisional application No. 60/480,443, filed on Jun. 23, 2003.

(51) Int. Cl. B29C 45/74

(52) U.S. Cl. 425/549

(57) ABSTRACT

An injection molding hot runner manifold with a double or back-up heater, where each heater is capable of producing adequate heat to heat a melt channel zone. The first heater can work independently of the second heater. In one example, the second heater can function as a back-up in the event that the first heater fails, therefore extending the time before the mold has to undergo repairs.

### CROSS REFERENCE TO RELATED APPLICATIONS

This application claims benefit under 35 U.S.C. §119(e) to U.S. Provisional Patent Application No. 60/480,443, filed Jun. 23, 2003, which is incorporated by reference herein in its entirety.

### BACKGROUND OF THE INVENTION

1. Field of the Invention

The present invention relates generally to an injection molding apparatus and, in particular, to a hot runner manifold with double heaters.

2. Related Art

There are many ways to heat injection molding hot runner manifolds. However, two methods are typically used: (1) through external means, in which a heater device is located on the surface of the manifold or (2) through internal means, in which a heater device is located inside the manifold.

The manifold is heated externally from the top, bottom, one or more sides, or through combinations of these surfaces. There are three main distinct types of heating devices generally used for external heating: heater elements, plate heaters, and film heaters.

If more heat is required near the melt channel, cartridge heaters are inserted into the manifold to be closer to the melt channels.

In order to perform maintenance on or replacement of a heater device, the mold is first removed from the injection molding machine, the manifold is cooled down and disassembled to replace the faulty heater. This leads to unscheduled and possibly lengthy periods of down time.

Therefore, what is needed is a system and method that allows for elimination or a substantial reduction in downtime related to maintenance or replacement of heaters used to heat manifolds of an injection molding machine.

### SUMMARY OF THE INVENTION

An embodiment of the present invention provides an injection molding hot runner apparatus having a manifold, a groove, and a heating system. The manifold has a melt channel to transport melt from a source to a nozzle. The manifold also has a top surface, a bottom surface, and at least one side surface. The groove is in at least one of the top or bottom surfaces. The heating system is positioned at least partially in the groove, the heating system has at least two portions. Each of the at least two portions is separately capable of sufficiently heating the melt channel to allow melt to flow therethrough.

Another embodiment of the present invention provides an injection molding hot runner apparatus having a manifold and a heating system. The manifold has a melt channel to transport melt from a source to a nozzle. The manifold also has a top surface, a bottom surface, and at least one side surface. The heating system has at least two portions coupled proximate each other on either the top or bottom surface. Each of the at least two portions is separately capable of sufficiently heating the melt channel to allow melt to flow therethrough.

Further embodiments, features, and advantages of the present invention, as well as the structure and operation of the various embodiments of the present invention are described in detail below with reference to accompanying drawings.

### BRIEF DESCRIPTION OF THE FIGURES

The accompanying drawings, which are incorporated herein and form a part of the specification, illustrate various embodiments of the present invention and, together with the description, further serve to explain the principles of the invention and to enable a person skilled in the pertinent art to make and use the invention.

FIG. 1 is a top view of a manifold with two heater elements inserted in one manifold groove, according to one embodiment of the present invention.

FIG. 2 is a cross-sectional view of a manifold with two heater elements in one manifold groove, according to one embodiment of the present invention.

FIG. 3 is a cross-sectional view of a manifold with two heater elements stacked in one manifold groove, according to one embodiment of the present invention.

FIG. 4 is a cross-sectional view of a manifold with two heater coils in one heater element in a manifold groove, according to one embodiment of the present invention.

FIG. 5 is a cross-sectional view of a manifold with two heater elements inserted into one manifold groove on the top surface and one manifold groove on the bottom surface, according to one embodiment of the present invention.

FIG. 6 is a cross-sectional view of a manifold with two heater elements inserted in two manifold grooves on the top surface, according to one embodiment of the present invention.

FIG. 7 is a cross-sectional view of a manifold with two heater elements inserted in one manifold groove on the bottom surface of the manifold, according to one embodiment of the present invention.

FIG. 8 is a cross-sectional view of a manifold with two film heaters attached to the top and bottom surface of the manifold, according to one embodiment of the present invention.

FIG. 9 is a cross-sectional view of a manifold with plate heaters having two heater elements, according to one embodiment of the present invention.

FIG. 10 is a cross-sectional view of a manifold with embedded and plate heaters on both a top surface and a bottom surface of the manifold, according to one embodiment of the present invention.

FIG. 11 is a cross-sectional view of a manifold with one embedded heater and series of plate heaters on a top surface of the manifold, according to one embodiment of the present invention.

FIG. 12 is a top view for a manifold heater arrangement, according to one embodiment of the present invention.

FIG. 13 is a cross-sectional view of a manifold with element heaters on a top and a bottom surface of a manifold and plate heaters on the top and a side surface of the manifold, according to one embodiment of the present invention.

FIG. 14 is a cross-sectional view of a manifold with one element on the top, and plate heaters on the side of the manifold, according to one embodiment of the present invention.

FIG. 15 illustrates a partial sectional view of an injection molding machine in which the present invention may be utilized.

The present invention will now be described with reference to the accompanying drawings. In the drawings, like reference numbers may indicate identical or functionally similar elements.

### DETAILED DESCRIPTION OF THE INVENTION

Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

One or more embodiments of the present invention provide a system that include a manifold coupled to a heating system including at least first and second portions. Each portion is capable of heating the manifold sufficiently to allow melt to flow through a melt channel in the manifold between a source of melt and a nozzle. In one example, through use of at least two heating portions, if one were to fail, the other can be used to heat the melt. Thus, in this example, there is redundancy in heating of the melt channel and the melt therein. In another example, both heating portions can operate at the same time in order to generate extra heat to maintain the melt at a desired temperature. This substantially reduces downtime, and thus increases throughput of an injection molding machine.

Overall System

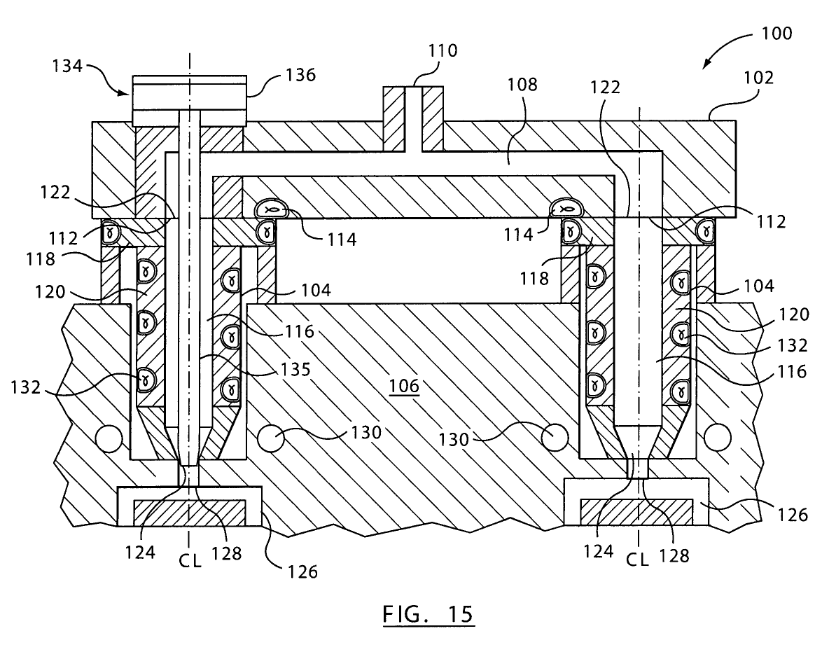

FIG. 15 illustrates a partial sectional view of an injection molding machine or apparatus 100, in which the present invention may be utilized. Apparatus 100 includes a manifold 102, a plurality of nozzles 104, and a mold plate 106. Manifold 102 has a plurality of manifold channels 108 extending therethrough from an inlet 110 to a plurality of outlets 112. Manifold 102 includes a heater 114 for heating melt in the manifold channels 108.

In various examples, heater 114 can be any one of a cartridge heater, a heating element with coils therein, a heating plate with heating elements having coils therein, a film heater, or the like. All are contemplated within the scope of the present invention. The operation of these and similar heaters is known in the art, and thus not fully described herein.

A nozzle melt channel 116 passes through a head portion 118 and a body portion 120 of nozzle 104, extending from an inlet 122 in head portion 118 to an outlet 124 in body portion 120. Head portion 118 abuts against a downstream surface of manifold 102 so that one of manifold channel outlets 112 communicates with inlet 122 of nozzle melt channel 116. Nozzle melt channel 116 may be generally longitudinally centered in head and body portions 118 and 120, i.e., melt channel 116 may extend generally along axis CL.

Mold plate 106 includes a plurality of mold cavities 126 in which injection molded articles are formed. Each mold cavity 126 receives melt through a gate 128, which is in communication with outlet 124 from one of nozzles 104. Mold plate 106 may be cooled by means of a fluid flowing through a plurality of cooling channels 130, to solidify melt in mold cavities 126, thereby forming molded articles (not shown).

Each nozzle 104 includes a heater 132 that is wrapped around body portion 120.

By example in FIG. 15, one of nozzles 104 includes a valve gating element 134. Valve gating element 134 includes a valve pin 135 that is movable within nozzle melt channel 116 by means of an actuator 136. The other one of nozzles 104 is thermally gated, and thus does not include a valve pin.

In use, melt passes from a melt source (not shown), through manifold inlet 110, through manifold channels 108, through nozzle melt channels 116, through gate 128 and into melt cavities 126.

First Exemplary Heater Configuration

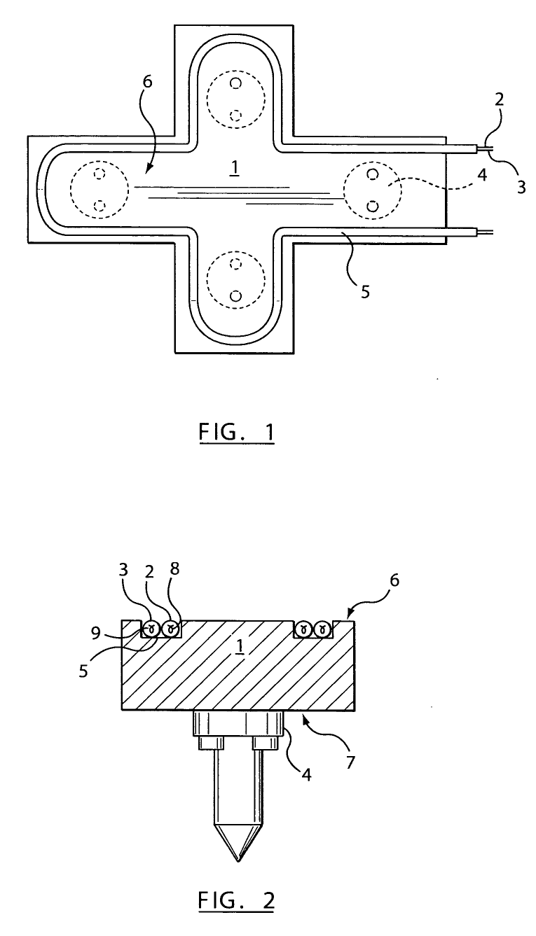

Each heating configuration shown in FIGS. 1 to 14 can be implemented in the environment shown in FIG. 15.

FIG. 1 is a top view of a manifold 1 with two heater elements 2 and 3 inserted (embedded) in a manifold groove 5, according to one embodiment of the present invention. In one example, heater elements 2 and 3, and/or other heater elements described herein below, can be used rather than heater 114 shown in FIG. 15. In FIG. 1, an injection molding hot runner system has melt channels (not shown) for transporting a melt from a source (not shown) though manifold 1 to plurality of nozzles 4. The melt channels in manifold 1 are heated using first heating element 2 and second heating element 3 located in manifold groove 5 on a top surface 6 of manifold 1. It is to be appreciated that, although FIG. 1 only shows one manifold groove 5, the use of more then one manifold groove 5 is also within the purview of this invention.

Exemplary Heating Element Arrangements

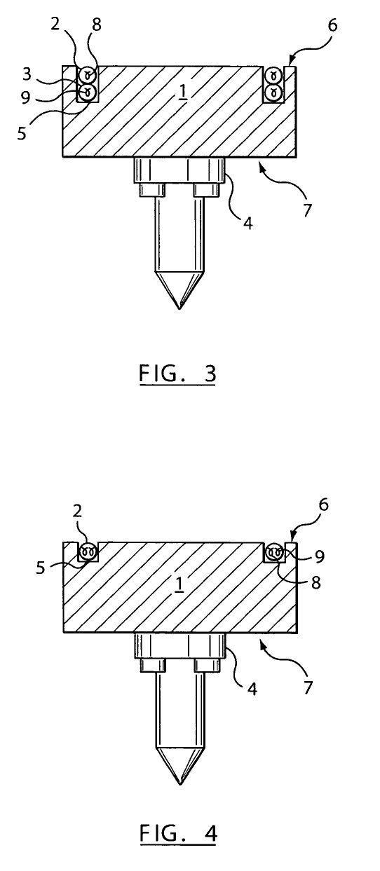

FIGS. 2 through 4 show possible arrangements for installing first heating element 2 and second heating element 3 into manifold groove 5, according to various embodiments of the present invention.

FIG. 2 is a cross-sectional view of manifold 1 having bottom surface 7 with heater elements 2 and 3 in manifold groove 5, according to one embodiment of the present invention. First heating element 2 has a first heating coil 8 and second heating element 3 has a second heating coil 9. First heating element 2 is installed parallel and adjacent to second heating element 3 in manifold groove 5.

FIG. 3 is a cross-sectional view of manifold 1 with two heater elements 2 and 3 stacked in manifold groove 5, according to one embodiment of the present invention. First heating element 2 is stacked on top of second heating element 3 in manifold groove 5.

FIG. 4 is a cross-sectional view of manifold 1 with heater coils 8 and 9 in one heater element 2 in a manifold groove 5, according to one embodiment of the present invention.

Exemplary Manifold Groove Arrangements

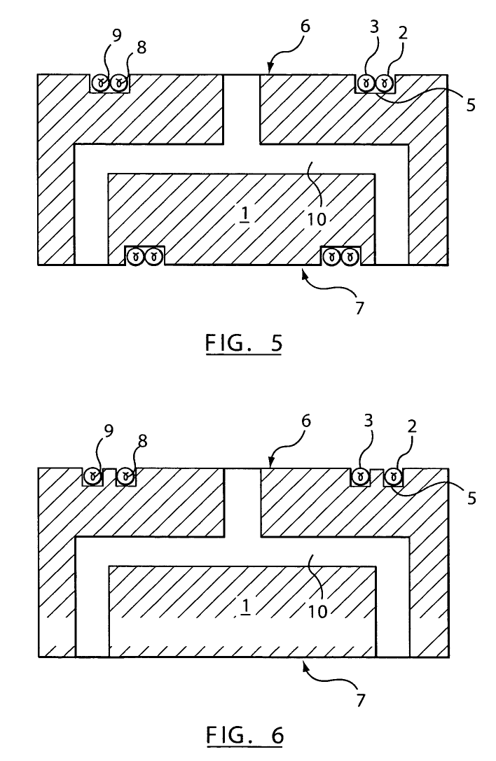

FIGS. 5 through 7 show cross-sectional views of manifold 1, according to various embodiments of the present invention. In FIGS. 5 through 7, manifold 1 includes a melt channel 10, top surface 6, and bottom surface 7, with different configurations of one or more manifold grooves 5.

FIG. 5 is a cross-sectional view of a manifold 1 with two heater elements 2 and 3 inserted in manifold groove 5 on top surface 6 and each of manifold groove 5 on bottom surface 7, according to one embodiment of the present invention.

FIG. 6 is a cross-sectional view of a manifold 1 with two heater elements 2 and 3 inserted in two separate manifold grooves 5 on top surface 6, according to one embodiment of the present invention.

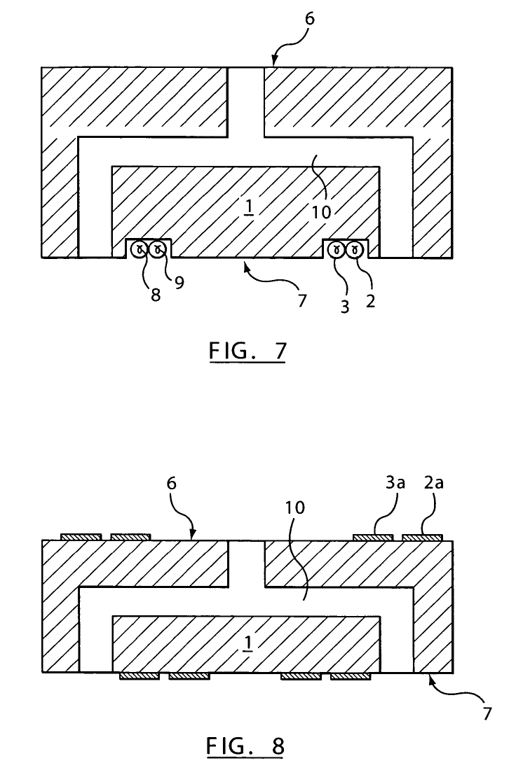

FIG. 7 is a cross-sectional view of a manifold 1 with two heater elements 2 and 3 inserted in manifold groove 5 on bottom surface 7 of manifold 1, according to one embodiment of the present invention.

It is to be appreciated that, although heater elements 2 and 3 are shown in a certain configuration in each manifold groove 5, any configuration, for examples the ones discussed above with respect to FIGS. 2 through 4, can be used for heater elements 2 and 3.

Exemplary Heater Arrangement Using Film Heaters

FIG. 8 show a cross-sectional view of manifold 1 with a first film heater 2a and a second film heater 3a on top surface 6 and bottom surface 7 of manifold 1, according to one embodiment of the present invention.

It is to be appreciated that in alternative embodiments first film heater 2a and second film heater 3a may be configured on manifold 1 in various arrangements on various surfaces, which are all contemplated within the scope of the present invention.

Exemplary Heating Arrangement Using Plate heaters

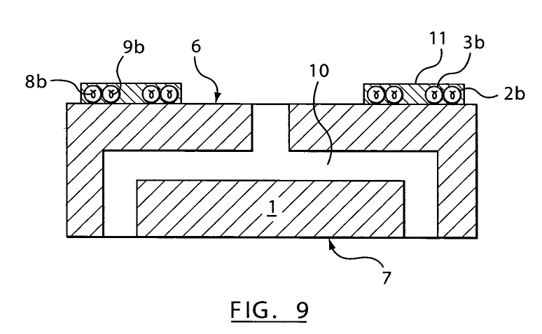

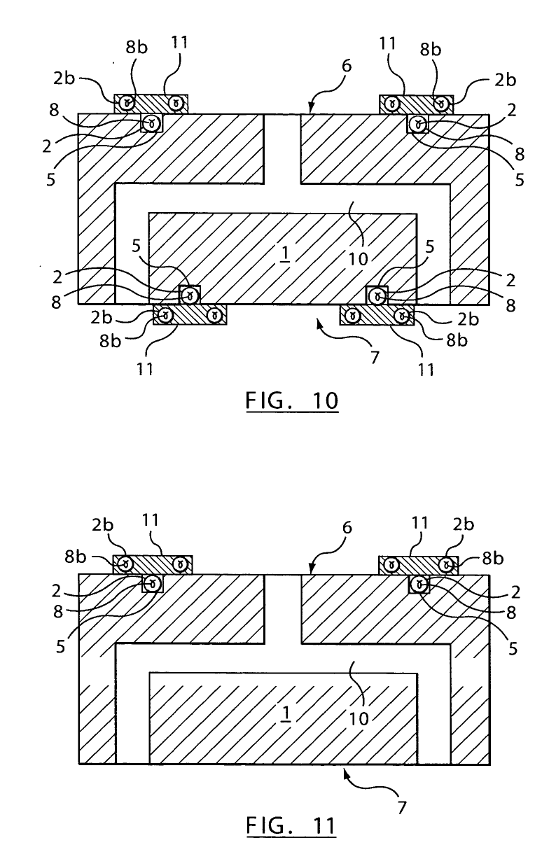

FIG. 9 is a cross-sectional view of a manifold 1 with plate heater 11 having two heater elements 2b and 3b therein, according to one embodiment of the present invention. Plate heater 11 has first heating element 2b and second heating element 3b located on top surface 6 of manifold 1.

It is to be appreciated that one or more plate heaters 11 can be attached to any surface of manifold 1. It is also to be appreciated that a heating element 2b or 3b, or both, can contain two heating coils (e.g., coil 8b or 9b), as illustrated in FIG. 4. These and other alternative arrangements are contemplated within the scope of the present invention.

Exemplary Embodiments Having Plate Heaters and Heater Elements

FIGS. 10 to 14 show configurations having combinations of both plate heaters 11 and heater elements 2 and/or 3 with coils 8 and/or 9, respectively, according to alternative embodiments of the present invention. Other configurations for combinations of one or more plate heaters 11 and one or more heater elements 2 and/or 3 with coils 8 and/or 9, respectively, not shown, are also contemplated within the scope of the present invention.

FIG. 10 shows each manifold groove 5 having heater element 2 and plate heaters 11 on both top and bottom surfaces 6 and 7, respectively, of manifold 1. In this embodiment, each plate heater 11 is shown to have heater element 2b with coil 8b, respectively, and is positioned to cover an opening of manifold groove 5. However, one or more plate heaters 11 can be used that include two heaters 2b and 3b with respective coils 8b or 9b.

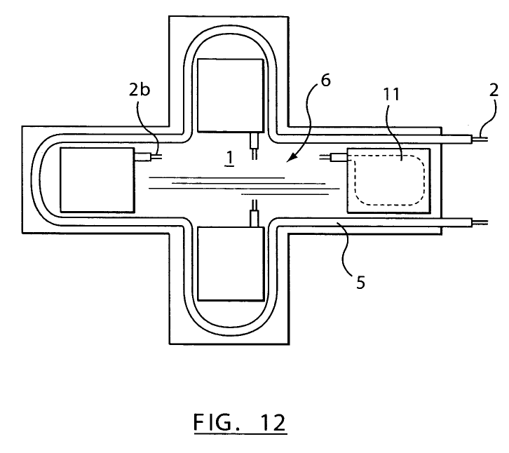

FIG. 11 shows manifold groove 5 having one heater element 2 and top surface 6 having a plate heater 11. In this embodiment, each plate heater 11 is shown to have heater element 2b with coil 8b, respectively, and is positioned to cover an opening of manifold groove 5. However, one or more plate heaters 111 can be used that include two heaters 2b and 3b with respective coils 8b or 9b.

FIG. 12 is a top view of the embodiment shown in either FIG. 10 or 11.

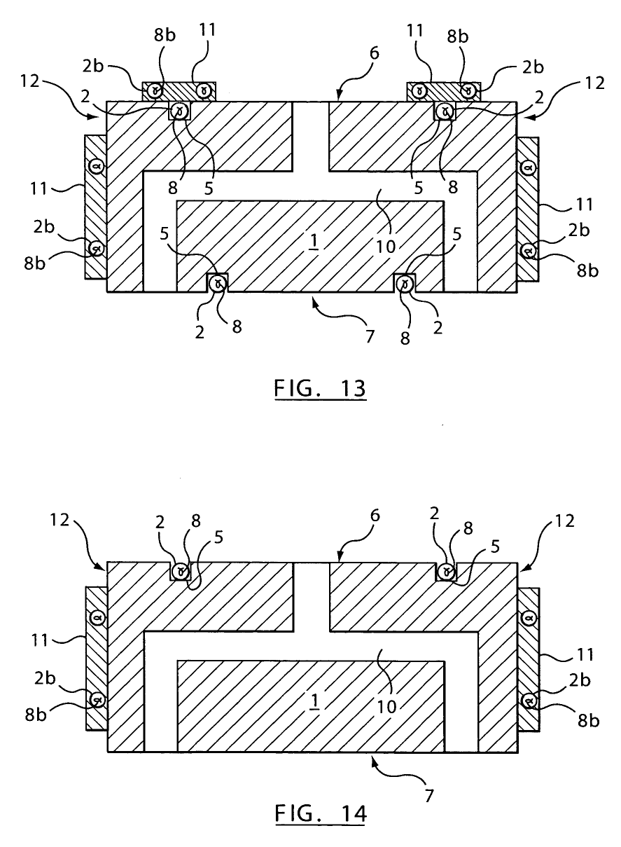

FIG. 13 shows element heaters 2 with coils 8 in manifold grooves 5 on top and bottom surfaces 6 and 7, respectively, and a plate heater 11 on top surface 6 and an outside surface 12. Plate heater 11 includes element 2b with respective coil 8b therein. Plate heater 11 on top surface 6 is positioned to cover an opening of manifold groove 5. However, one or more plate heaters 11 can be used that include two heaters 2b and 3b with respective coils 8b or 9b.

FIG. 14 shows an element 2 with coil 8 in manifold groove 5 on top surface 6 and plate heater 11 on outside surface 12. Plate heater 11 includes element 2b with respective coil 8b therein. However, one or more plate heaters 11 can be used that include two heaters 2b and 3b with respective coils 8b or 9b.

The configurations of FIGS. 13 and 14 show that plate heaters 11 do not have to actually be overlapping heating elements 2 and/or manifold grooves 5, just positioned so that they heat substantially a same zone of manifold 1 as one or more heating elements 2 and/or 3.

It will be appreciated by persons skilled in the art that heating devices can also include cartridge heaters located inside manifold 1. For example, two cartridge heaters can be located adjacent to each other in such a way as to ensure that both heaters are independently capable of heating a given area of the melt channel.

It should also be appreciated by persons skilled in the art that there could be a first heating device located on the top surface of the manifold and a second heating device located in the same manner on the bottom surface of the manifold designed to be capable of heating the melt channels independent of each other.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. An injection molding hot runner apparatus, comprising:
a manifold having a melt channel to transport melt from a source to a nozzle, the manifold having a top surface, a bottom surface, and at least one side surface;
a groove in at least one of the top or bottom surfaces; and
a heating system positioned at least partially in the groove, the heating systems have at least two portions, wherein each of the at least two portions is separately capable of sufficiently heating the melt channel to allow melt to flow therethrough.

2. The injection molding hot runner apparatus of claim 1, wherein said heating system comprises:
first and second heating elements having coils therein positioned proximate each other in the groove in the top surface of the manifold.

3. The injection molding hot runner apparatus of claim 2, wherein the first and second heating elements are positioned side-by-side in the groove on the top surface.

4. The injection molding hot runner apparatus of claim 2, wherein the first and second heating elements are positioned in respective first and second ones of the groove on the top surface.

5. The injection molding hot runner apparatus of claim 2, wherein the first and second heating elements are positioned one on top of another in the groove on the top surface.

6. The injection molding hot runner apparatus of claim 1, wherein said heating system comprises:
a heating element in the groove in the top surface having two heating coils therein.

7. The injection molding hot runner apparatus of claim 1, wherein said heating system comprises:
first and second heating elements having coils therein positioned proximate each other in a first one of the grooves in the top surface of the manifold; and
third and fourth heating elements having coils therein positioned proximate each other in a second one of the grooves in the bottom surface of the manifold.

8. The injection molding hot runner apparatus of claim 7, wherein:
the first and second heating elements are positioned either side-by-side or one on top of another in the first groove in the top surface; and
the third and fourth heating elements are positioned either side-by-side or one on top of another in the second groove in the bottom surface.

9. The injection molding hot runner apparatus of claim 1, wherein said heating system comprises:
first and second heating elements having coils therein positioned proximate each other in respective first and second ones of the groove in the top surface of the manifold; and
third and fourth heating elements having coils therein positioned proximate each other in respective third and fourth ones of the groove in the bottom surface of the manifold.

10. The injection molding hot runner apparatus of claim 1, wherein said heating system comprises:
first and second heating elements having coils therein positioned proximate each other in the groove in the bottom surface of the manifold.

11. The injection molding hot runner apparatus of claim 10, wherein the first and second heating elements are positioned side-by-side in the groove in the bottom surface.

12. The injection molding hot runner apparatus of claim 10, wherein the first and second heating elements are positioned one on top of another in the groove in the bottom surface.

13. The injection molding hot runner apparatus of claim 10, wherein the first and second heating elements are positioned in respective first and second ones of the groove in the bottom surface.

14. The injection molding hot runner apparatus of claim 1, wherein the heating system comprises:
a first heating plate having two heating elements therein, the heating plate being coupled to the top surface of the manifold;
a first one of the heating element having a coil therein, the first heating element being positioned in a first one of the groove in the top surface of the manifold;
a second heating plate having two heating elements therein, the second heating plate being coupled to the bottom surface of the manifold; and
a second heating element having a coil therein, the second heating element being positioned a second one of the groove in the bottom surface of the manifold.

15. The injection molding hot runner apparatus of claim 1, wherein the heating system comprises:
a heating plate having two heating elements therein, the heating plate being coupled to the top surface of the manifold; and
a heating elements having a coil therein, the heating element being positioned in the groove in the top surface of the manifold.

16. The injection molding hot runner apparatus of claim 1, wherein the heating system comprises:
a first heating plate having two heating elements therein, the heating plate being coupled to the top surface of the manifold;
a first heating element having a coil therein, the heating element being positioned in a first one of the groove in the top surface of the manifold;
a second heating plate having two heating elements therein, the second heating plate being coupled to an outside surface of the manifold; and
a second heating element having a coil therein, the second heating element being positioned in second one of the groove in the bottom surface of the manifold.

17. The injection molding hot runner apparatus of claim 1, wherein the heating system comprises:
a heating plate having two heating elements therein, the first heating plate being coupled to an outside surface of the manifold; and
a heating element having a coil therein, the heating element being positioned in the groove in the top surface of the manifold.

18. An injection molding hot runner apparatus, comprising:
a manifold having a melt channel to transport melt from a source to a nozzle, the manifold having a top surface, a bottom surface, and at least one side surface; and
a heating system have at least two portions coupled proximate each other on either the top or bottom surface, wherein each of the at least two portions is separately capable of sufficiently heating the melt channel to allow melt to flow therethrough.

19. The injection molding hot runner apparatus of claim 18, wherein the at least two portions of the heating system comprises:
a heating plate having first and second heating elements with a coil in each, the heating plate being coupled to the top surface of the manifold.

20. The injection molding hot runner apparatus of claim 18, wherein the at least two portions of the heating system comprises:
a first film heater coupled to the top surface of the manifold; and
a second film heater couple to the bottom surface of the manifold.
